(19) United States
(12) Patent Application Publication
(10) Pub. No.: US 2023/0199196 A1
(43) Pub. Date: Jun. 22, 2023

(54) Methods and Apparatuses of Frequency Domain Mode Decision in Video Encoding Systems

(71) Applicant: MEDIATEK INC., Hsinchu City (TW)

(72) Inventors: Chen-Yen LAI, Hsinchu City (TW); Ching-Yeh CHEN, Hsinchu City (TW); Tzu-Der CHUANG, Hsinchu City (TW); Chih-Wei HSU, Hsinchu City (TW); Chun-Chia CHEN, Hsinchu City (TW); Yu-Wen HUANG, Hsinchu City (TW)

(21) Appl. No.: 17/702,396

(22) Filed: Mar. 23, 2022

Related U.S. Application Data
(60) Provisional application No. 63/291,968, filed on Dec. 21, 2021.

(51) Int. Cl. H04N 19/154; H04N 19/103; H04N 19/18; H04N 19/176

(52) U.S. Cl. CPC H04N 19/154; H04N 19/103; H04N 19/18; H04N 19/176

(57) ABSTRACT

Video encoding methods and apparatuses for frequency domain mode decision include receiving residual data of a current block, testing multiple coding modes on the residual data, calculating a distortion associated with each of the coding modes in a frequency domain, performing a mode decision to select a best coding mode from the tested coding modes according to the distortion calculated in the frequency domain, and encoding the current block based on the best coding mode.

### CROSS REFERENCE TO RELATED APPLICATIONS

The present invention claims priority to U.S. Provisional Patent Application, Ser. No. 63/291,968, filed on Dec. 21, 2021, entitled “Frequency Domain Mode Decision”. The U.S. Provisional Patent Application is hereby incorporated by reference in its entirety.

### FIELD OF THE INVENTION

The present invention relates to video data processing methods and apparatuses for video encoding. In particular, the present invention relates to frequency domain mode decision in video encoding.

### BACKGROUND AND RELATED ART

The Versatile Video Coding (VVC) standard is the latest video coding standard developed by the Joint Collaborative Team on Video Coding (JCT-VC) group of video coding experts from ITU-T Study Group. The VVC standard inherited former High Efficiency Video Coding (HEVC) standard which relies on a block-based coding structure, where each video picture contains one or a collection of slices and each slice is divided into an integer number of Coding Tree Units (CTUs). The individual CTUs in a slice are processed according to a raster scanning order. Each CTU is further recursively divided into one or more Coding Units (CUs) to adapt to various local motion and texture characteristics. The prediction decision is made at the CU level, where each CU is encoded according to a best coding mode selected according to a Rate Distortion Optimization (RDO) technique. The video encoder exhaustively tries multiple mode combinations to select a best coding mode for each CU in terms of maximizing the coding quality and minimizing bit rates. A specified prediction process is employed to predict the values of associated pixel samples inside each CU. A residual signal is a difference between the original pixel samples and predicted values of the CU. After obtaining the residual signal generated by the prediction stage, residual data of the residual signal belong to a CU is then transformed into transform coefficients for compact data representation. These transform coefficients are quantized and conveyed to the decoder. The terms Coding Tree Block (CTB) and Coding block (CB) are defined to specify two-dimensional sample array of one color component associated with the CTU and CU respectively. For example, a CTU consists of one luminance (luma, Y) CTB, two chrominance (chroma, Cb and Cr) CTBs, and its associated syntax elements.

In the video encoder, video data of a CU may be computed by a Low-Complexity (LC) RDO stage followed by a High-Complexity (HC) RDO stage. For example, prediction is performed in the low-complexity RDO stage to compute the Rate Distortion (RD) cost while Differential Pulse Code Modulation (DPCM) is performed in the high-complexity RDO stage to compute the RD cost. For example, in the low-complexity RDO stage, a distortion value such as a Sum of Absolute Transform Difference (SATD) or Sum of Absolute Difference (SAD) associated with a prediction mode applied to a CU is computed for determining a best prediction mode for the CU. In the high-complexity RDO stage, a distortion of a prediction mode is calculated by comparing a reconstructed residual signal and an input residual signal. The RD cost of the corresponding prediction mode is derived by adding the bits-cost of the residual signal to the distortion. The reconstructed residual signal is generated by processing the input residual signal through the transform operation 12, quantization operation 14, inverse quantization operation 16, and inverse transform operation 18 as shown in FIG. 1. In many video coding standards, the type II Discrete Cosine Transform (DCT-II) is the transformation technique applied in the transform operation 12 and the type II inverse DCT (invDCT-II) is the inverse transformation technique applied in the inverse transform operation 18. N sets of transform, quantization, inverse quantization, and inverse transform hardware circuits are needed to test N prediction modes at the same time in a video encoder, where N is an integer greater than 1. To simplify the mode decision of a group of prediction modes, low complexity RDO is performed to check on the predictors associated with various prediction modes. However, low complexity RDO does not work for a prediction mode group in which the predictors of all modes are the same. The mode decision of this prediction mode group can only be made by performing high complexity RDO to determine the best prediction mode with a lowest RD cost.

### BRIEF SUMMARY OF THE INVENTION

In various embodiments of a video encoding method according to the present invention, a video encoding system receives residual data of a current block, tests N coding modes on the residual data of the current block, calculates a distortion associated with each of the coding modes in a frequency domain, performs a mode decision to select a best coding mode from the tested coding modes according to the distortion calculated in the frequency domain, and encodes the current block based on the best coding mode. N is a positive integer greater than 1. In some embodiments of the present invention, the best coding mode is selected according to the distortions calculated in the frequency domain and rates of the N tested coding modes. Embodiments of the present invention perform the mode decision in a high-complexity RDO stage to calculate a frequency domain distortion by comparing frequency domain residual data before and after quantization and inverse quantization. Predictors of the current block associated with the N coding modes are the same, in some embodiments, the residual data associated with the N coding modes tested by the video encoding system are also the same. For example, testing N coding modes on the residual data of the current block comprises transforming the residual data into transform coefficients, applying quantization to the transform coefficients of each coding mode to generate quantized levels, and applying inverse quantization to the quantized levels of each coding mode; and encoding the current block comprises applying inverse transform to reconstructed transform coefficients associated with the best coding mode to generate reconstructed residual data of the current block. The distortion associated with each coding mode is calculated by comparing the transform coefficients and reconstructed transform coefficients of each coding mode. According to an embodiment, inverse transform is applied after performing the mode decision and only the reconstructed transform coefficients associated with the best coding mode is inverse transformed. An embodiment of the N coding modes is Skip mode and Merge mode for one Merge candidate.

In one embodiment, the N coding modes include different secondary transform modes, and testing N coding modes on the residual data of the current block comprises transforming the residual data into transform coefficients, transforming the transform coefficients into secondary transform coefficients by different secondary transform modes, applying quantization to the secondary transform coefficients of each coding mode to generate quantized levels, applying inverse quantization to the quantized levels of each coding mode, and applying inverse secondary transform to generate reconstructed transform coefficients for each secondary transform mode. In this embodiment, encoding the current block comprises applying inverse transform to reconstructed transform coefficients associated with the best coding mode to generate reconstructed residual data for the current block.

In some other embodiments, predictors of the current block associated with the N coding modes may be the same but residual data associated with the N coding modes are different. Testing N coding modes on the residual data of the current block comprises transforming the residual data associated with each coding mode into transform coefficients, applying quantization to the transform coefficients of each coding mode to generate quantized levels, and applying inverse quantization to the quantized levels of each coding mode. Encoding the current block comprises applying inverse transform to reconstructed transform coefficients associated with the best coding mode to generate reconstructed residual data of the current block. In one embodiment, the distortion associated with each coding mode is calculated by comparing the transform coefficients and reconstructed transform coefficients of each coding mode. In one embodiment, the N coding modes include different Joint Coding of Chroma Residuals (JCCR) modes. In this embodiment, a distortion of the best coding mode selected from the JCCR modes is calculated in a spatial domain, and a distortion of a non-JCCR mode is calculated in the spatial domain. The distortions in the spatial domain are compared and a best coding mode is updated according to the comparing result of the spatial domain distortions. In another embodiment, N coding modes are different JCCR modes and a non-JCCR mode. In yet another embodiment, the N coding modes are different Merge candidates or Inter modes.

Aspects of the disclosure further provide an apparatus for the video encoding system to perform a mode decision according to frequency domain distortions. The apparatus comprises one or more electronic circuits configured for receiving residual data of a current block, testing a plurality of coding modes on the residual data of the current block, calculating a distortion associated with each of the coding modes in a frequency domain, performing the mode decision to select a best coding mode from the tested coding modes according to the distortions calculated in the frequency domain, and encoding the current block based on the best coding mode. Other aspects and features of the invention will become apparent to those with ordinary skill in the art upon review of the following descriptions of specific embodiments.

### BRIEF DESCRIPTION OF THE DRAWINGS

Various embodiments of this disclosure that are proposed as examples will be described in detail with reference to the following figures, wherein like numerals reference like elements, and wherein:

FIG. 1 illustrates an encoding flow of a basic high complexity Rate Distortion Optimization (RDO) stage with a distortion calculated in a spatial domain.

FIG. 2 illustrates an encoding flow of the high complexity RDO stage with a distortion calculated in a frequency domain according to embodiments of the present invention.

FIG. 3 illustrates an encoding flow of the high complexity RDO for testing multiple coding modes with the same residual signal according to a first embodiment of the present invention.

FIG. 4 illustrate an encoding flow for making a mode decision between multiple coding modes with different residual signals according to a second embodiment of the present invention.

FIG. 5 illustrates an encoding flow of making a mode decision between three LFNST modes in the spatial domain according to a spatial domain mode decision method.

FIG. 6 illustrates an encoding flow of making a mode decision between three LFNST modes in a frequency domain according to the first embodiment of the present invention.

FIG. 7 illustrates an exemplary encoding flow for making a mode decision between non-JCCR mode and three JCCR modes in a spatial domain.

FIG. 8 illustrates an encoding flow of making a mode decision between three JCCR modes in a frequency domain and making mode decision between a non-JCCR mode and the best JCCR mode in a spatial domain according to an example of the second embodiment of the present invention.

FIG. 9 illustrates an encoding flow of making a mode decision between three JCCR modes and non-JCCR mode in a frequency domain according to another example of the second embodiment of the present invention.

FIG. 10 is a flowchart illustrating an embodiment of the video encoding method for deciding a coding mode according to a distortion calculated in a frequency domain.

FIG. 11 illustrates an exemplary system block diagram for a video encoding system incorporating one or a combination of the video encoding methods according to some embodiments of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention.

Reference throughout this specification to “an embodiment”, “some embodiments”, or similar language means that a particular feature, structure, or characteristic described in connection with the embodiments may be included in at least one embodiment of the present invention. Thus, appearances of the phrases “in an embodiment” or “in some embodiments” in various places throughout this specification are not necessarily all referring to the same embodiment, these embodiments can be implemented individually or in conjunction with one or more other embodiments. Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention.

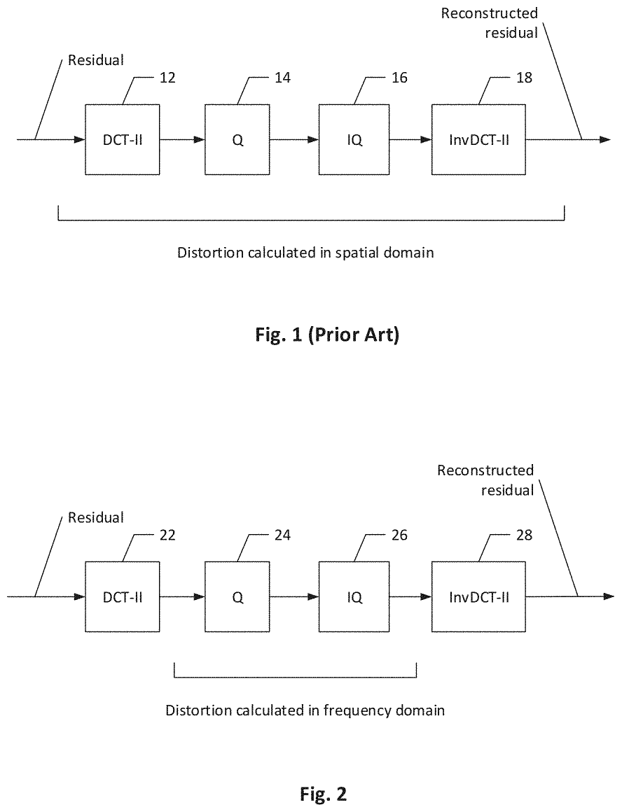

Mode Decision in Frequency Domain In the High-Complexity (HC) Rate Distortion Optimization (RDO) stage, a video encoder complied with the VVC standard applies transform (DCT-II) 12, quantization (Q) 14, inverse quantization (IQ) 16, and inverse transform (invDCT-II) 18 operations to residual data of a current block as shown in FIG. 1. A distortion for the HC RDO stage is normally derived in a spatial domain by calculating a difference between a reconstructed residual signal and an input residual. Experiment results indicate the distortion calculated in the spatial domain and the distortion calculated in the frequency domain are similar. Embodiments of the present invention therefore rely on the distortion calculated in the frequency domain to make the mode decision in the HD RDO stage. FIG. 2 illustrates the encoding flow of the HC RDO stage with the distortion calculated in the frequency domain. The encoding flow of FIG. 2 includes the transform operation (DCT-II) 22, quantization operation (Q) 24, inverse quantization operation (IQ) 26, and inverse transform operation (invDCT-II) 28. The distortion calculated in the frequency domain refers to a difference between a transformed residual signal and an inverse quantized residual signal. The transformed residual signal is a signal output from the transform operation 22 and the inverse quantized residual signal is a signal output from the inverse quantization operation 26.

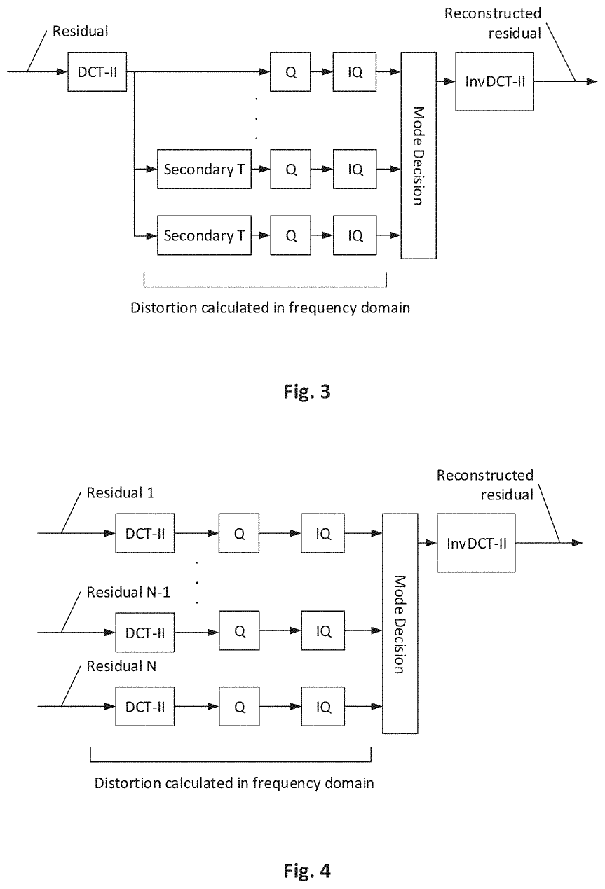

An obvious benefit of calculating the distortion in the frequency domain for mode decision over calculating the distortion in the spatial domain is the hardware cost reduction. The hardware cost for implementing the spatial domain mode decision method is higher than the hardware cost for implementing the frequency domain mode decision method as there are more hardware circuits can be shared by multiple coding modes when implementing the frequency domain mode decision method. In a first embodiment of the present invention, N coding modes with the same residual data are tested in the HC RDO stage by a video encoder, N sets of quantization and inverse quantization circuits are needed for the mode decision in the frequency domain. However, only one transform circuit and one inverse transform circuit are needed for the mode decision in the frequency domain according to the first embodiment, which is less than N transform circuits and N inverse transform circuits needed for the mode decision in the spatial domain. An example of the prediction modes having the same residual in the first embodiment is different modes in Low Frequency Non-Separable Transform (LFNST). Another example of the first embodiment is the mode decision between the Skip mode and Merge mode for the same Merge candidate. LFNST only employs in low-frequency coefficients, that is, only the low-frequency coefficients of the secondary transformation are retained while the high-frequency coefficients are assumed to be zero. The distortion is the sum of non-zero coefficient region distortion and zero coefficient region distortion. However, the zero coefficient region distortion can be calculated in non-LFNST case. Only non-zero coefficient region distortion needs to be calculated when LFNST is employed. It results in less samples used to calculate the distortion in the frequency domain compared to the number of samples used to calculate the distortion in the spatial domain. FIG. 3 illustrates an encoding flow of the HC RDO stage for testing N coding modes with the same residual signal according to the first embodiment of the present invention. In the first embodiment, the video encoder tests N coding modes, and a dedicated quantization circuit and a dedicated inverse quantization circuit are used to process the transform coefficients associated with each of the N coding modes. One of the N coding modes disables the secondary transform while the other coding modes are associated with different secondary transforms applied after the primary transform. A mode decision circuit selects a best coding mode corresponding to a lowest RD cost, where RD costs of the N coding modes are derived according to the distortions calculated in the frequency domain. An inverse transform circuit can be shared by the N coding modes.

In a second embodiment of the present invention, N coding modes with different residual data are tested in the HC RDO stage by the video encoder, that is, N sets of transform, quantization, and inverse quantization circuits are needed for processing residual data of the N coding modes in parallel for the frequency domain mode decision method. FIG. 4 illustrate an encoding flow for making a mode decision in the frequency domain according to the second embodiment. Comparing to the encoding flow for making a mode decision in the spatial domain, where N inverse transform circuits are needed for the N coding modes, one inverse transform circuit in the second embodiment can be shared by the N coding modes. In the VVC standard, the zero-out technology applied in the frequency domain will reduce the number of samples used to calculate the distortion in the frequency domain when the width or height of the transform block is larger than 32 samples, which leads to lower computational complexity in the HC RDO stage. For transform blocks having a width or height larger than 32 samples, samples outside 32×32 low frequency samples will not be used for distortion calculation in the frequency domain, the number of samples used to calculate the frequency domain distortion is less than the number of samples used to calculate the spatial domain distortion. For transform blocks smaller than or equal to 32×32 samples, the number of samples used to calculate the frequency domain distortion is equal to the number of samples used to calculate the spatial domain distortion. In the second embodiment, examples of the coding modes with different residual data are Joint Coding of Chroma Residuals (JCCR) and mode decision between different Merge candidates or different Inter modes.

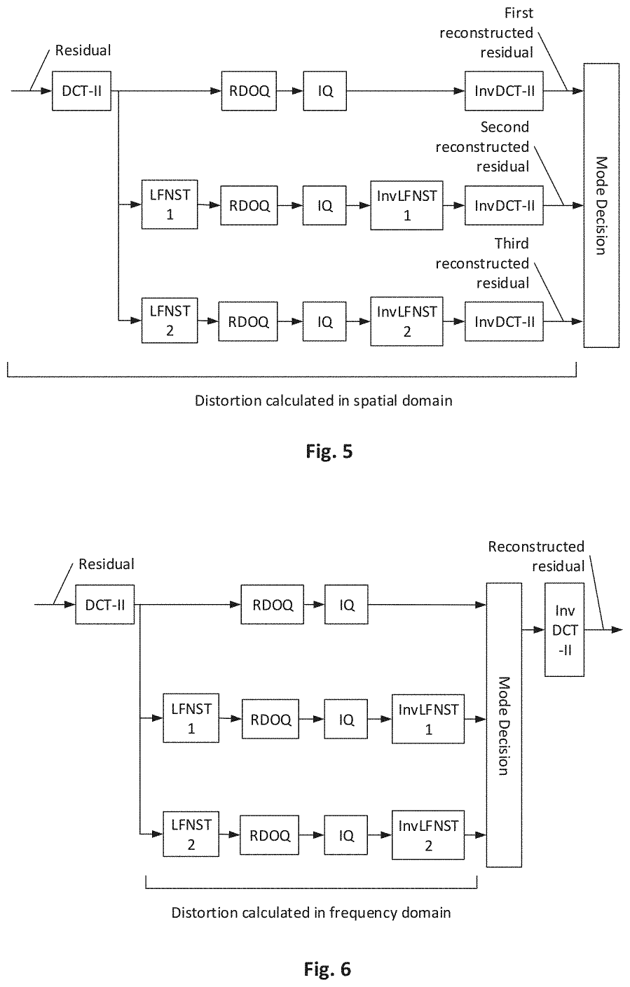

Example of the First Embodiment: Frequency Domain Mode Decision for LFNST Low Frequency Non-Separable Transform (LFNST) is a secondary transform operation performed after the primary transform operation (e.g. DCT-II) in intra coded Transform Blocks (TBs). LFNST converts the frequency domain signal from one transform domain to another by transforming primary transform coefficients to secondary transform coefficients. The normative constraint in the VVC standard restricts the LFNST coding tool to be applied on TBs having both width and height larger than or equal to 8. In the single tree case, LFNST is only applied on the luma component, whereas in the dual tree case, the LFNST mode decisions for the luma and chroma components are separated. LFNST uses a matrix multiplication approach to decrease the computational complexity. FIG. 5 illustrates an encoding flow of making the mode decision between three LFNST modes in the spatial domain according to a spatial domain mode decision method. The three LFNST modes are LFNST off, LFNST kernel 1, and LFNST kernel 2. For the LFNST off mode, an input residual signal of a current TB is processed by primary transform, quantization, inverse quantization, and inverse primary transform operations to generate a first reconstructed residual signal. The HC RDO stage in the video encoder performs primary transform, LFNST secondary transform according to the LFNST kernel 1 and 2, quantization, inverse quantization, inverse LFNST secondary transform, and inverse primary transform operations to generate a second reconstructed residual signal for the current TB and a third reconstructed residual signal for the current TB. The video encoder then computes RD costs associated with the three LFNST modes according to the distortions calculated in the spatial domain. The distortion of the LFNST off mode refers to a difference between the input residual signal and the first reconstructed residual signal, the distortion of the LFNST kernel 1 mode refers to a difference between the input residual signal and the second reconstructed residual signal, and the distortion of the LFNST kernel 2 mode refers to a difference between the input residual signal and the third reconstructed residual signal. The RD cost associated with a LFNST mode considers the bit required for encoding the residual data by the LFNST mode and a distortion calculated in the spatial domain. The LFNST mode corresponds to the lowest RD cost among the three RD costs is selected for the current TB. In this parallel LFNST mode decision example, the size of the hardware transform circuits for quantization, inverse quantization, and inverse primary transform increases to three times. To simplify the mode decision of a group of coding modes, a LC RDO check is usually performed on the predictor of each coding mode. However, the low complexity check does not work for the mode decision between the LFNST modes because the predictors of different LFNST modes are all the same. The mode decision for LFNST can only be done by the HC RDO stage.

FIG. 6 illustrates an encoding flow of making the mode decision between three LFNST modes in the frequency domain according to the first embodiment of the present invention. The frequency domain distortion associated with each LFNST mode is calculated to derive a corresponding RD cost for each LFNST mode. For example, the frequency domain distortion for the LFNST off mode compares the primary transform coefficients output from the primary transform operation (DCT-II) and inverse quantized coefficients output from the inverse quantization operation (IQ), and the frequency domain distortion for the LFNST kernel 1 mode compares the primary transform coefficients output from the primary transform operation (DCT-II) and inverse secondary transform coefficients output from the inverse LFNST kernel 1 operation. Similarly, the frequency domain distortion for the LFNST kernel 2 mode compares the primary transform coefficients output from the primary transform operation (DCT-II) and inverse secondary transform coefficients output from the inverse LFNST kernel 2 operation. An exemplary mode decision module selects the LFNST mode with the lowest distortion, and passes the coefficients corresponding to the selected LFNST mode to the inverse primary transform operation (invDCT-II) to generate a reconstructed residual signal. In another example, the mode decision module selects the LFNST mode with the lowest RD cost and passes the coefficients to the inverse primary transform operation to generate a reconstructed residual signal. The frequency domain mode decision for the three LFNST modes as shown in FIG. 6 reduces the hardware cost increasing for LFNST mode decision as it only requires one inverse primary transform circuit (InvDCT-II) while three inverse primary transform circuits (InvDCT-II) are required by the spatial domain mode decision. The inverse primary transform circuit (InvDCT-II) can be shared by the three LFNST modes in the frequency domain mode decision. The number of samples used to calculate the frequency domain distortion is less than the number of samples used to calculate the spatial domain distortion due to LFNST only applied on the low-frequency coefficients. After the residual data being transformed by the primary transform circuit (DCT-II), only the top-left three coefficient groups of each transform block are feed to the LFNST kernel (i.e. LFNST kernel 1 or LFNST kernel 2) circuit. The secondary transform circuit (LFNST1 or LFNST 2) of FIG. 6 applies the LFNST kernel 1 mode or LFNST kernel 2 mode to the top-left 3 coefficient groups to generate 1 non-zero coefficient group and 2 zero coefficient groups. Consequently, only one coefficient group in each transform block needs to be processed by the quantization (RDOQ) and inverse quantization (IQ) circuits. The RDOQ circuit applies quantization to two additional coefficient groups (2×4×4 samples). The additional buffer needed for the LFNST data pre-stage is 2×3×4×4 +2×4×4, including the buffer used for storing inverse quantized coefficients of 3 coefficient groups for LFNST kernel 1 and LFNST kernel 2 and the buffer used for storing quantized coefficients of 2 coefficient groups for LFNST kernel 1 and LFNST kernel 2. The RD costs for the frequency domain mode decision between the LFNST modes are computed according to the distortions in the frequency domain and the rates required for encoding the residual data. The frequency domain distortion of the LFNST kernel 1 mode or LFNST kernel 2 mode is equal to the distortion of the top-left 3 coefficient groups plus the distortion of the zero region within the transform block. The zero-region distortion associated with the LFNST kernel 1 mode or LFNST kernel 2 mode can be directly obtained from the LFNST off mode. The rate of the frequency domain mode decision for LFNST is computed according to top-left 16 sample level rates in one coefficient group plus LFNST index bits. The top-left 16 sample level rates in one coefficient group includes greater than one flag, parity flag, greater than 3 flag, and remaining part. Since primary transform filtering is applied by linear operation, theoretically, the ratio between distortion calculated in frequency domain and in spatial domain shall always be a constant value. As a result, the frequency domain LFNST mode decision can mimic spatial domain LFNST full search to test both LFNST kernel 1 and LFNST kernel 2 with small hardware cost increasing. The mode decision for the three LFNST modes is made before inverse primary transform processing, one inverse primary transform circuit is needed instead of three inverse primary transform circuits. The distortion calculated in the spatial domain and the distortion calculated in the frequency domain are similar so the loss of frequency domain mode decision LFNST is relatively small.

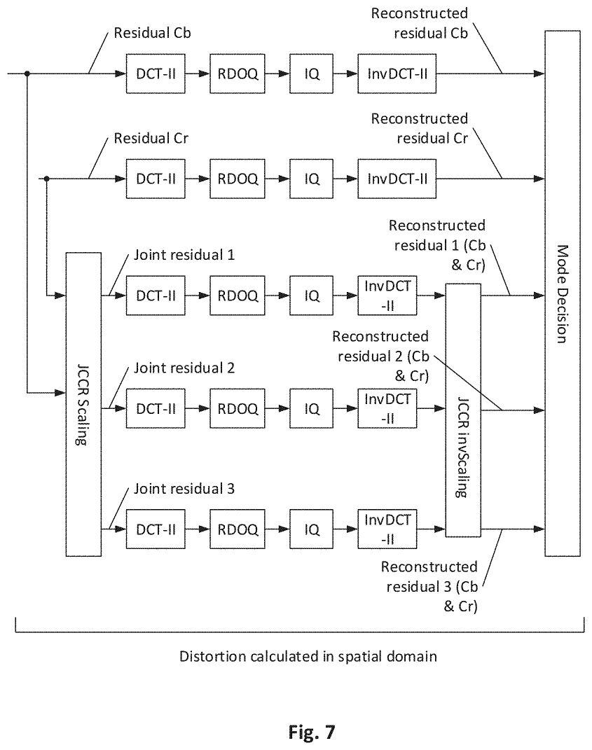

Example of the Second Embodiment: Frequency Domain Mode Decision for JCCR Removing correlation in the quantized chroma residual signal can be efficiently exploited using a Joint Coding of Chroma Residuals (JCCR) mode in which only one joint residual data resJointC is signaled and is used to derive residual data for both chroma components Cb and Cr. The video encoder determines residual data resCb for the Cb block and residual data resCr for the Cr block, where residual data resCb and resCr represent a difference between the respective original chroma block and predicted chroma block. In a JCCR mode, rather than coding resCb and resCr separately, the video encoder constructs joint residual data, resJointC, according to resCb and resCr to reduce the amount of information signaled to video encoders. For example, resJointC=resCb+CSign*weight*resCr, where C Sign is a sign value signaled in the slice header. There are three allowed weights for intra Transform Units (TUs) and 1 allowed weight for non-intra TUs. The video encoder receives information for the joint residual data and generates residual data resCb′ and resCr′ for the two chroma components. FIG. 7 illustrates an exemplary encoding flow for making a mode decision between non-JCCR mode and three JCCR modes in the spatial domain. Each JCCR mode corresponds to a different weight applied to construct the joint residual data. As shown in FIG. 7, three additional sets of hardware transform circuits including transform, quantization, inverse quantization, and inverse transform circuits are needed to implement parallel mode decision for the three JCCR modes and non-JCCR mode. In the second embodiment, the mode decision can only be worked with high complexity RDO as the predictors of different JCCR modes and non-JCCR mode are all the same. The spatial domain distortion associated with the non-JCCR mode is a sum of a Cb distortion and a Cr distortion, where the Cb distortion is computed by comparing Cb residual data with Cb reconstructed residual data and the Cr distortion is computed by comparing Cr residual data with Cr reconstructed residual data. The spatial domain distortion associated with a first JCCR mode is a sum of a Cb1 distortion and a Cr1 distortion, where the Cb1 distortion is computed by comparing Cb residual data with a Cb part of reconstructed residual data 1, and the Cr1 distortion is computed by comparing Cr residual data with a Cr part of the reconstructed residual data 1.

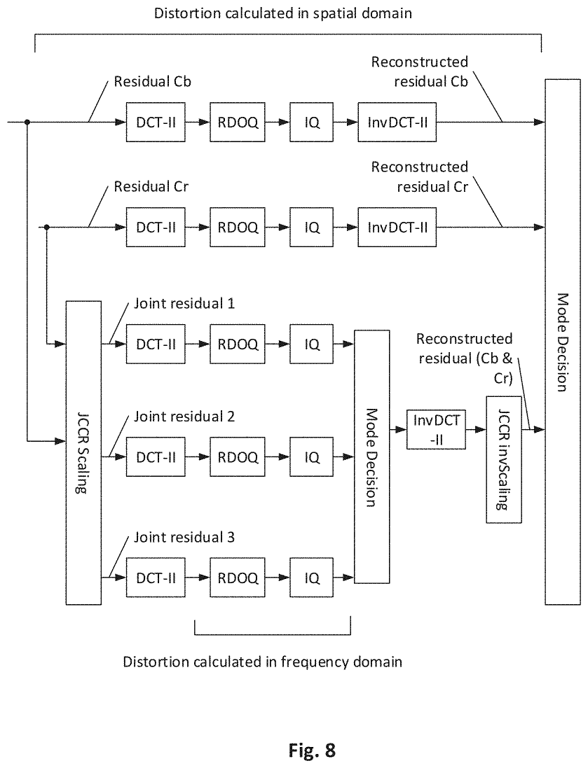

FIG. 8 illustrates an encoding flow of making a mode decision between three JCCR modes in the frequency domain and making a mode decision between non-JCCR mode and the selected JCCR mode in the spatial domain according to an example of the second embodiment of the present invention. The three JCCR modes share one inverse transform circuit by selecting a best JCCR mode according to RD costs or distortions calculated in the frequency domain. In this example, joint residual data corresponding to the three JCCR modes are generated by a JCCR scaling operation. The joint residual data corresponding to each JCCR mode is separately processed by transform (DCT-II), quantization (RDOQ), and inverse quantization (IQ) operations, and a frequency domain distortion associated with each JCCR mode is calculated by comparing transform coefficients output from the transform operation and inverse quantization coefficients output from the inverse quantization operation. A mode decision module selects a best JCCR mode out of the three JCCR modes according to the frequency domain distortions or RD costs derived from the frequency domain distortions. The inverse quantization coefficients associated with the best JCCR mode are inverse transformed by the shared inverse transform circuit (InvDCT-II) and inverse scaling by a JCCR inverse scaling operation to generate reconstructed Cb residual data and reconstructed Cr residual data. A spatial domain distortion of the best JCCR mode is the sum of Cb2 distortion and Cr2 distortion. Cb2 distortion is computed by comparing the original Cb residual data and the reconstructed Cb residual data of the best JCCR mode. Cr2 distortion is computed by comparing the original Cr residual data and the reconstructed Cr residual data of the best JCCR mode. Residual data of each of the chroma components Cb and Cr are processed by transform (DCT-II), quantization (RDOQ), inverse quantization (IQ), and inverse transform (InvDCT-II) operations to generate reconstructed residual data for the chroma components Cb and Cr. A spatial domain distortion of the non-JCCR mode is the sum of Cb3 distortion and Cr3 distortion. Cb3 distortion is calculated by comparing the original Cb residual data and reconstructed Cb residual data. Cr3 distortion is calculated by comparing the original Cr residual data and the reconstructed Cr residual data. Another mode decision module compares the spatial domain distortions or RD costs derived from the spatial domain distortions to select a best coding mode out of the best JCCR mode and the non-JCCR mode.

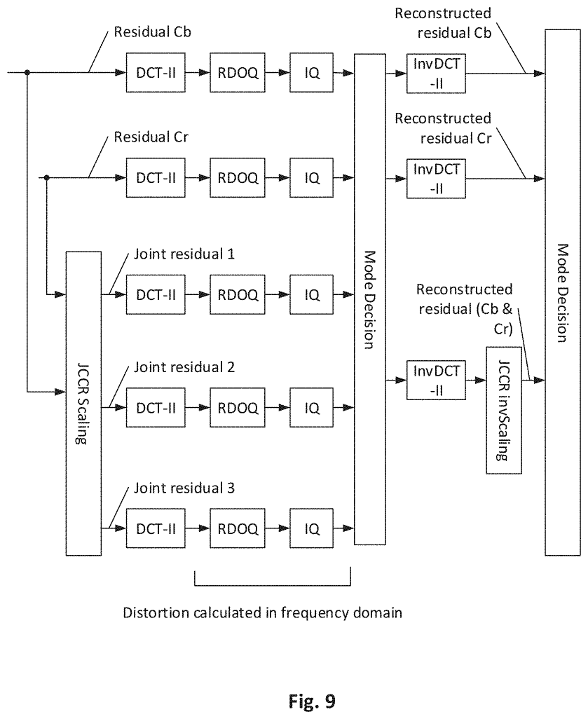

FIG. 9 illustrates an encoding flow of making a mode decision between three JCCR modes and a non-JCCR mode in the frequency domain according to another example of the second embodiment of the present invention. The frequency domain Cb or Cr distortion of the Cb residual data or the Cr residual data coded in the non-JCCR mode is computed by comparing respective transform coefficients before quantization and after inverse quantization, and the frequency domain distortion associated with the non-JCCR mode is a sum of the Cb distortion and Cr distortion calculated in the frequency domain. The frequency domain distortion of each joint residual data associated with a JCCR mode is computed by comparing respective transform coefficients before quantization and after inverse quantization and multiplying by a scaling factor. It is because that the non-JCCR mode distortion is associated with the sum of frequency domain distortion of Cb and Cr, and the JCCR mode distortion is only associated with a joint residual data. For example, the scaling factor can be 2. In another embodiment, the frequency domain distortion of each joint residual data associated with a JCCR mode is computed by comparing respective transform coefficients of Cb and Cr before quantization and the reconstructed inverse quantization data of Cb and Cr, where the reconstructed inverse quantization data Cb and Cr are generated by processing a joint residual data of a JCCR mode with transform, quantization, inverse quantization and JCCR inverse scaling. The mode decision module of the video encoder selects one of the three JCCR modes or the non-JCCR mode with a lowest RD cost or frequency domain distortion. Two inverse transform circuits (InvDCT-II) for the non-JCCR mode apply inverse transform processing to the transform coefficients associated with the Cb and Cr components if the mode decision module selects the non-JCCR mode, otherwise an inverse transform circuit (InvDCT-II) for the JCCR mode applies inverse transform processing to the transform coefficients associated with the selected JCCR mode. The inverse transform circuit (InvDCT-II) for the JCCR mode and non-JCCR mode can be shared. In other words, the inverse transform circuit (InvDCT-II) for the JCCR mode is one of the inverse transform circuit (InvDCT-II) for non-JCCR mode. After applying inverse transform processing for the transform coefficient associated with the selected JCCR mode, the reconstructed joint residual data is recovered by JCCR inverse scaling.

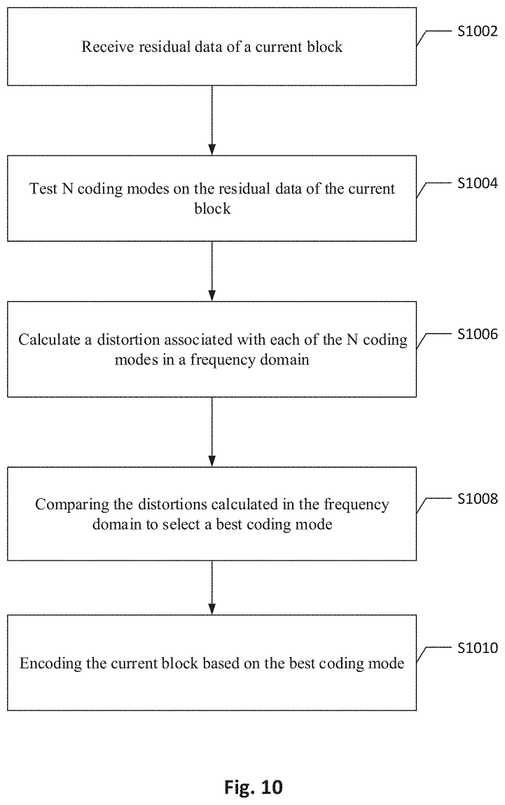

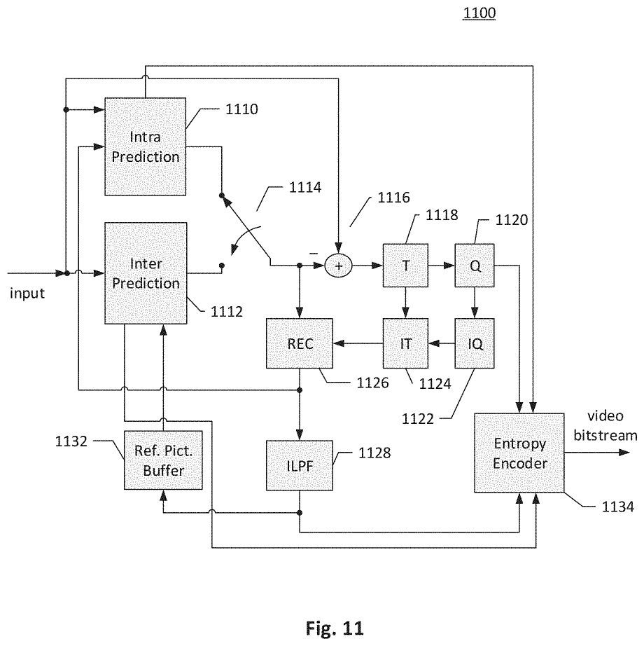

Representative Flowchart for Mode Decision According to Frequency Domain Distortions FIG. 10 is a flowchart illustrating implementing an exemplary embodiment of the frequency domain mode decision method in a video encoding system. In step S1002, the video encoding system receives residual data of a current block. The current block is a Coding Unit (CU), Coding Block (CB), Transform Unit (TU), Transform Block (TB), or a combination thereof. The video encoding system tests N coding modes on the residual data of the current block in step S1004 and calculates a distortion associated with each of the N coding modes in a frequency domain in step S1006. The video encoding system performs a mode decision by comparing the distortions calculated in the frequency domain for selecting a best coding mode in step S1008. In step S1010, the current block is encoded based on the best coding mode.

Representative System Block Diagrams FIG. 11 illustrates an exemplary system block diagram for a Video Encoder 1100 implementing one or more embodiments of the frequency domain mode decision method. Intra Prediction module 1110 provides intra predictors based on reconstructed video data of a current picture. Inter Prediction module 1112 performs Motion Estimation (ME) and Motion Compensation (MC) to provide predictors based on referencing video data from other picture or pictures. Either Intra Prediction module 1110 or Inter Prediction module 1112 supplies the selected predictor to Adder 1116 to form a residual signal. In some embodiments, the residual signal of the current block is the same for N coding modes, the residual signal is processed by Transformation module (T) 1118 to generate transform coefficients. The transform coefficients of each coding mode are processed by Quantization module (Q) 1120 followed by Inverse Quantization module (IQ) 1122. A distortion is calculated in the frequency domain for each of the N coding modes. A best coding mode is selected by comparing the frequency domain distortions or both rates and distortions of the N coding modes. The output of the IQ module 1122 associated with the best coding mode is processed by Inverse Transformation module (IT) 1124 to recover the prediction residual signal. In some other embodiments, residual data of the current block are different for each of the N coding modes, the residual data associated with each of the N coding modes are processed by Transformation module (T) 1118, Quantization module (Q) 1120, Inverse Quantization module (IQ) 1122. A distortion is calculated in the frequency domain for each of the N coding modes, and a best coding mode is selected by comparing the frequency domain distortions or both rates and distortions of the N coding modes. The output of IQ module 1122 associated with the best coding mode is processed by IT 1124 to recover the residual signal.

Transformed and quantized residual signal of the best coding mode is encoded by Entropy Encoder 1130 to form a video bitstream. The video bitstream is then packed with side information. As shown in FIG. 11, the residua signal is recovered by adding back to the selected predictor at Reconstruction module (REC) 1126 to produce reconstructed video data. The reconstructed video data may be stored in Reference Picture Buffer (Ref. Pict. Buffer) 1132 and used for prediction of other pictures. The reconstructed video data from REC module 1126 may be subject to various impairments due to the encoding processing, consequently, In-loop Processing Filter (ILPF) 1128 is applied to the reconstructed video data before storing in the Reference Picture Buffer 1132 to further enhance picture quality. Syntax elements are provided to Entropy Encoder 1130 for incorporation into the video bitstream.

Various components of Video Encoder 1100 in FIG. 11 may be implemented by hardware components, one or more processors configured to execute program instructions stored in a memory, or a combination of hardware and processor. For example, a processor executes program instructions to calculate a distortion in a frequency domain. The processor is equipped with a single or multiple processing cores. In some examples, the processor executes program instructions to perform functions in some components in Encoder 1100, and the memory electrically coupled with the processor is used to store the program instructions, information corresponding to the reconstructed images of blocks, and/or intermediate data during the encoding process. The memory in some embodiment includes a non-transitory computer readable medium, such as a semiconductor or solid-state memory, a Random Access Memory (RAM), a Read-Only Memory (ROM), a hard disk, an optical disk, or other suitable storage medium. The memory may also be a combination of two or more of the non-transitory computer readable medium listed above.

Embodiments of the video data processing method performing a specific process in a video encoding system may be implemented in a circuit integrated into a video compression chip or program code integrated into video compression software to perform the processing described above. For examples, scaling transform coefficient levels in a current transform block may be realized in program code to be executed on a computer processor, a Digital Signal Processor (DSP), a microprocessor, or field programmable gate array (FPGA). These processors can be configured to perform specific tasks according to the invention, by executing machine-readable software code or firmware code that defines the methods embodied by the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A video encoding method for a video encoding system, comprising:
receiving residual data of a current block;
testing N coding modes on the residual data of the current block, wherein N is a positive integer greater than 1;
calculating a distortion associated with each of the N coding modes in a frequency domain;
performing a mode decision to select a best coding mode from the N tested coding modes according to the distortions calculated in the frequency domain; and
encoding the current block based on the best coding mode.

2. The method of claim 1, wherein the best coding mode is selected according to the distortions calculated in the frequency domain and rates of encoding the residual data according to the N tested coding modes.

3. The method of claim 1, wherein predictors of the current block associated with the N coding modes are the same and the residual data of the current block associated with the N coding modes are the same.

4. The method of claim 3, wherein testing N coding modes on the residual data of the current block comprises transforming the residual data into transform coefficients, applying quantization to the transform coefficients of each coding mode to generate quantized levels, and applying inverse quantization to the quantized levels of each coding mode; and encoding the current block comprises applying inverse transform to reconstructed transform coefficients associated with the best coding mode to generate reconstructed residual data of the current block.

5. The method of claim 4, wherein the distortion associated with each coding mode is calculated by comparing the transform coefficients and reconstructed transform coefficients of each coding mode.

6. The method of claim 4, wherein inverse transform is applied after performing the mode decision and only the reconstructed transform coefficients associated with the best coding mode is inverse transformed.

7. The method of claim 4, wherein the N coding modes include Skip mode and Merge mode for one Merge candidate.

8. The method of claim 3, wherein the N coding modes include different secondary transform modes, and testing N coding modes on the residual data of the current block comprises transforming the residual data into transform coefficients, transforming the transform coefficients into secondary transform coefficients by different secondary transform modes, applying quantization to the secondary transform coefficients of each coding mode to generate quantized levels, applying inverse quantization to the quantized levels of each coding mode, and applying inverse secondary transform to generate reconstructed transform coefficients of each secondary transform mode; and encoding the current block comprises applying inverse transform to reconstructed transform coefficients associated with the best coding mode to generate reconstructed residual data for the current block.

9. The method of claim 1, wherein the residual data of the current block associated with the N coding modes are different.

10. The method of claim 9, wherein testing N coding modes on the residual data of the current block further comprises transforming the residual data associated with each coding mode into transform coefficients, applying quantization to the transform coefficients of each coding mode to generate quantized levels, and applying inverse quantization to the quantized levels of each coding mode; and encoding the current block further comprises applying inverse transform to reconstructed transform coefficients associated with the best coding mode to generate reconstructed residual data of the current block.

11. The method of claim 10, wherein the distortion associated with each coding mode is calculated by comparing the transform coefficients and reconstructed transform coefficients of each coding mode.

12. The method of claim 10, wherein the N coding modes include different Joint Coding of Chroma Residuals (JCCR) modes.

13. The method of claim 12, further comprising:
calculating a distortion of the best coding mode selected from the JCCR modes in a spatial domain;
calculating a distortion of a non-JCCR mode in the spatial domain;
comparing the distortions calculated in the spatial domain; and
updating the best coding mode according to the comparing result of the distortions calculated in the spatial domain.

14. The method of claim 10, wherein the N coding modes include different JCCR modes and a non-JCCR mode.

15. The method of claim 10, wherein the N coding modes include different Merge candidates or Inter modes.

16. An apparatus in a video encoding system, the apparatus comprising one or more electronic circuits configured for:
receiving residual data of a current block;
testing N coding modes on the residual data of the current block, wherein N is a positive integer greater than 1;
calculating a distortion associated with each of the N coding modes in a frequency domain;
performing a mode decision to select a best coding mode from the N tested coding modes according to the distortions calculated in the frequency domain; and
encoding the current block based on the best coding mode.
